(19) United States
(12) Patent Application Publication
(10) Pub. No.: US 2002/0196202 A1
(43) Pub. Date: Dec. 26, 2002

(54) Method for displaying emergency first responder command, control, and safety information using augmented reality

(76) Inventors: Mark Stanley Bastian, Manchester, NH (US); John Franklin Ebersole JR., Bedford, NH (US); John Franklin Ebersole, Bedford, NH (US); Daniel Alan Eads, New Port Richey, FL (US)

Correspondence Address: Brian M. Dingman, Esq., Mirick, O'Connell, DeMallie & Lougee, LLP, 1700 West Park Drive, Westborough, MA, 01581, US

(21) Appl. No.: 10/216,304

(22) Filed: Aug. 9, 2002

Related U.S. Application Data
(63) Continuation-in-part of application No. 09/634,203, filed on Aug. 9, 2000.

(51) Int. Cl. G09G 5/00

(52) U.S. Cl. 345/8

(57) ABSTRACT

A method is presented which uses Augmented Reality for visualization of text and other messages sent to an EFR by an incident commander. The messages are transmitted by the incident commander via a computer at the scene to an EFR/trainee in an operational or training scenario. Messages to an EFR/trainee, including (but not limited to) iconic representation of hazards, victims, structural data, environmental conditions, and exit directions/locations, are superimposed right onto an EFR/trainee's view of the real emergency/fire and structural surroundings. The primary intended applications are for improved safety for the EFR, and improved EFR-incident commander communications both on-scene and in training scenarios.

### CROSS REFERENCE TO RELATED APPLICATION

This application is a Continuation in Part of “Augmented Reality Navigation Aid” Ser. No. 09/634,203 filed Aug. 9, 2000.

### TECHNICAL FIELD OF THE INVENTION

This invention relates to the fields of firefighter and other emergency first responder (EFR) training, firefighter and other EFR safety, and augmented reality (AR). The purpose of the invention is to allow firefighters and EFRs to receive and visualize text messages, iconic representations, and geometrical visualizations of a structure as transmitted by the incident commander from a computer or other device, either on scene or at a remote location.

### COPYRIGHT INFORMATION

A portion of the disclosure of this patent document contains material that is subject to copyright protection. The copyright owner has no objection to the facsimile reproduction by anyone of the patent document or the patent disclosure as it appears in the Patent and Trademark Office records but otherwise reserves all copyright works whatsoever.

### BACKGROUND OF THE INVENTION

An incident commander or captain outside a structure where an emergency is taking place must be in contact with firefighters/emergency first responders (hereafter collectively referred to as EFRs) inside the structure for a number of reasons: he/she may need to transmit information about the structure to the EFR so a hazard, such as flames, can safely be abated; he/she may need to plot a safe path through a structure, avoiding hazards such as fire or radiation, so that the EFR can reach a destination safely and quickly; or he/she may need to transmit directions to an EFR who becomes disoriented or lost due to smoke or heat. Similarly, these and other emergency situations must be anticipated and prepared for in an EFR training environment.

One of the most significant and serious problems at a fire scene is that of audio communication. It is extremely difficult to hear the incident commander over a radio amidst the roar of flames, water and steam. If, for example, the commander was trying to relay a message to a team member about the location of a hazard inside the structure, there may be confusion due to not being able to clearly understand the message because of the level of noise associated with the fire and the extinguishing efforts. This common scenario places both EFRs and victim(s) at unacceptable risk.

The incident commander is also receiving messages from the EFRs. Unfortunately, the EFRs often have difficulty receiving messages from each other. With a technology in place that allows for easy communication between the incident commander and the EFRs, the incident commander can easily relay messages back to the other members of the EFR team. This allows EFRs to receive messages relevant to each other without having to rely on direct audio communication between EFRs.

### SUMMARY OF THE INVENTION

Using hardware technology available today that allows EFRs to be tracked inside a building, the invention is able to have the EFRs' locations within a structure displayed on a computer display present at the scene (usually in one of the EFR vehicles). This information allows an incident commander to maintain awareness of the position of personnel in order to ensure the highest level of safety for both the EFR(s) and for any victim(s). Instead of relying on audio communication alone to relay messages to the incident team, the commander can improve communication by sending a text or other type of message containing the necessary information to members of the incident team. Furthermore, current positional tracking technology can be coupled with an orientation tracker to determine EFR location and direction. This information would allow the incident commander to relay directional messages via an arrow projected into a display device, perhaps a display integrated into a firefighter's SCBA (Self Contained Breathing Apparatus). These arrows could be used to direct an EFR toward safety, toward a fire, away from a radiation leak, or toward the known location of a downed or trapped individual. Other iconic messages could include graphics and text combined to represent a known hazard within the vicinity of the EFR, such as a fire or a bomb.

These text or iconic messages can appear in an unobtrusive manner on a monocular device, which can be mounted directly in the EFR's face mask. The EFR continues to have a complete view of the real surrounding structure and real fire while the text or iconic message is superimposed on the EFR's view of the scene—the message can appear in the foreground of the display.

There is currently no comparable technology which utilizes Augmented Reality as a method for displaying command and control information to emergency first responders.

Augmented Reality (AR) is defined in this application to mean superimposing one or more computer-generated (virtual) graphical elements onto a view of the real world (which may be static or changing) and presenting the combined view to the user. In this application, the computer-generated graphical element is the text message, directional representation (arrow), other informative icon from the incident commander, or geometrical visualizations of the structure. It will be created via a keyboard, mouse or other method of input on a computer or handheld device at the scene. The real world view consists of the EFR's environment, containing elements such as fire, unseen radiation leaks, chemical spills, and structural surroundings. The EFR/trainee will be looking through a display, preferably be a monocular, head-mounted display (HMD) mounted inside the user's mask (an SCBA in the case of a firefighter). This monocular could also be mounted in a hazmat suit or onto a hardhat. The HMD will be preferably “see through,” that is, the real hazards and surroundings that are normally visible will remain visible without the need for additional equipment. Depending on the implementation and technology available, there may also be a need for a tracking device on the EFR's mask to track location and/or orientation. The EFR/trainee's view of the real world is augmented with the text message, icon, or geometrical visualizations of the structure—thus the result is referred to as Augmented Reality.

Types of messages sent to an EFR/trainee include (but are not limited to) location of victims, structural data, building/facility information, environmental conditions, and exit directions/locations.

This invention can notably increase the communication effectiveness at the scene of an incident or during a training scenario and result in safer operations, training, emergency response, and rescue procedures.

### BRIEF DESCRIPTION OF THE DRAWINGS

FIG. 1: A schematic diagram of the system components that can be used to accomplish the preferred embodiments of the inventive method.

FIG. 2: A conceptual drawing of a firefighter's SCBA with an integrated monocular eyepiece that the firefighter may see through.

FIG. 3: A view as seen from inside the HMD of a text message accompanied by an icon indicating a warning of flames ahead

FIG. 4: A possible layout of an incident commander's display in which waypoints are placed.

FIG. 5: A possible layout of an incident commander's display in which an escape route or path is drawn.

FIG. 6: A text message accompanied by an icon indicating that the EFR is to proceed up the stairs.

FIG. 7: A waypoint which the EFR is to walk towards.

FIG. 8: A potential warning indicator warning of a radioactive chemical spill.

FIG. 9: Wireframe rendering of an incident scene as seen by an EFR.

FIG. 10: A possible layout of a tracking system, including emitters and receiver on user.

### DETAILED DESCRIPTION OF THE PREFERRED EMBODIMENTS OF THE INVENTION

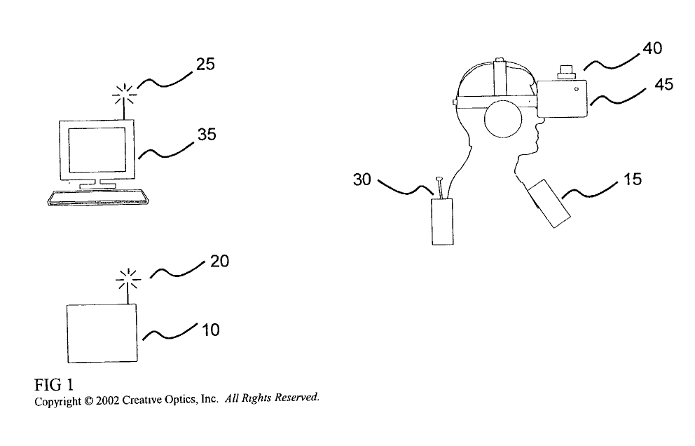

The inventive method can be accomplished using the system components shown in FIG. 1. The following items and results are needed to accomplish the preferred method of this invention:

A display device for presenting computer generated images to the EFR.

A method for tracking the position of the EFR display device.

A method for tracking the orientation of the EFR display device.

A method for communicating the position and orientation of the EFR display device to the incident commander.

A method for the incident commander to view information regarding the position and orientation of the EFR display device.

A method for the incident commander to generate messages to be sent to the EFR display device.

A method for the incident commander to send messages to the EFR display device's portable computer.

A method for presenting the messages, using computer generated images, sent by the incident commander to the EFR.

A method for combining the view of the real world seen at the position and orientation of the EFR display device with the computer-generated images representing the messages sent to the EFR by the incident commander.

A method for presenting the combined view to the EFR on the EFR display device.

EFR Display Device. In one preferred embodiment of the invention, the EFR display device (used to present computer-generated images to the EFR) is a Head Mounted Display (HMD) 45. There are many varieties of HMDs which would be acceptable, including see-through and non-see-through types. In the preferred embodiment, a see-through monocular HMD is used. Utilization of a see-through type of HMD allows the view of the real world to be obtained directly by the EFR. The manners in which a message is added to the display are described below.

In a second preferred embodiment, a non-see-through HMD would be used as the EFR display device. In this case, the images of the real world (as captured via video camera) are mixed with the computer-generated images by using additional hardware and software components known in the art.

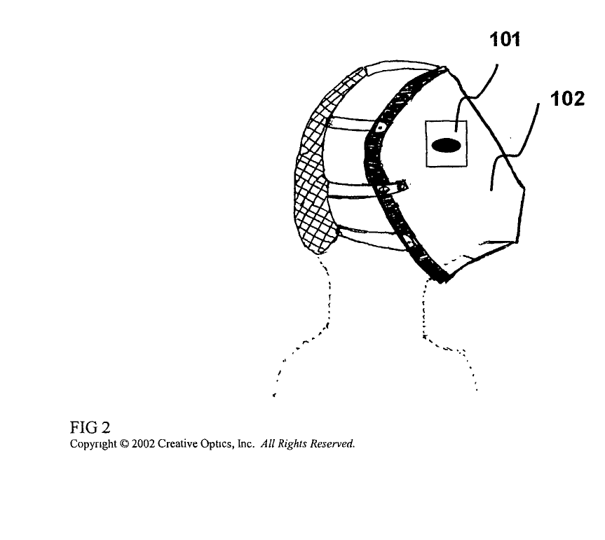

For preferred embodiments using an HMD as the EFR display device, a monocular HMD may be integrated directly into an EFR face mask which has been customized accordingly. See FIG. 2 for a conceptual drawing of an SCBA 102 with the monocular HMD eyepiece 101 visible from the outside of the mask. Because first responders are associated with a number of different professions, the customized face mask could be part of a firefighter's SCBA (Self-Contained Breathing Apparatus), part of a HAZMAT or radiation suit, or part of a hard hat.

The EFR display device could also be a hand-held device, either see-through or non-see-through. In the see-through embodiment of this method, the EFR looks through the “see-through” portion (a transparent or semitransparent surface) of the hand-held display device and views the computer-generated elements projected onto the view of the real surroundings.

Similar to the second preferred embodiment of this method (which utilizes a non-see-though HMD), if the EFR is using a non-see-though hand-held display device, the images of the real world (as captured via video camera) are mixed with the computer-generated images by using additional hardware and software components.

The hand-held embodiment of the invention may also be integrated into other devices (which would require some level of customization) commonly used by first responders, such as Thermal Imagers, Navy Firefighter's Thermal Imagers (NFTI), or Geiger counters.

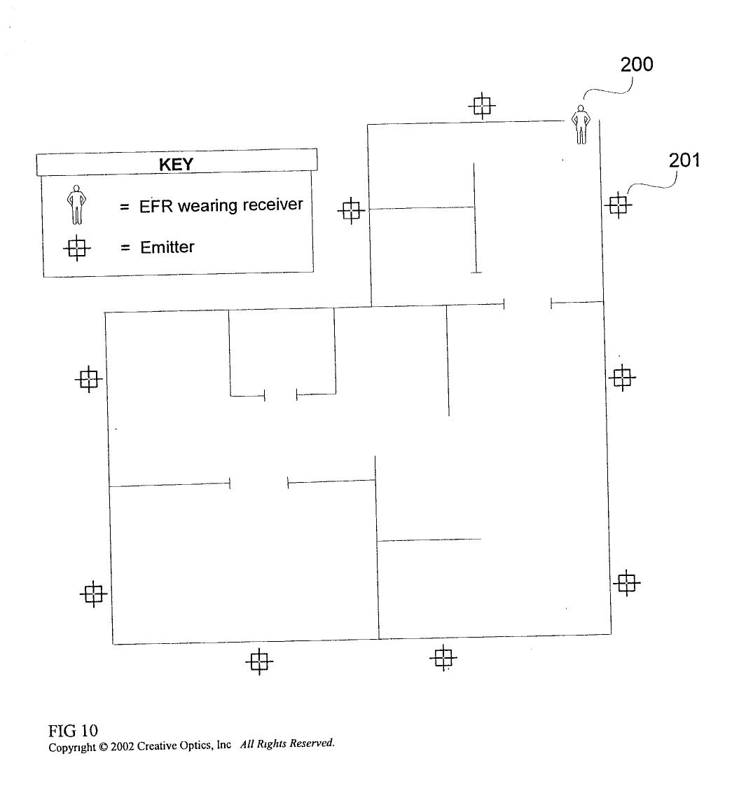

Method for Tracking the Position and Orientation of the EFR Display Device. The position of an EFR display device 15, 45 is tracked using a wide area tracking system. This can be accomplished with a Radio Frequency (RF) technology-based tracker. The preferred embodiment would use RF transmitters. The tracking system would likely (but not necessarily) have transmitters installed at the incident site 10 as well as have a receiver that the EFR would have with him or her 30. This receiver could be mounted onto the display device, worn on the user's body, or carried by the user. In the preferred embodiment of the method (in which the EFR is wearing an HMD), the receiver is also worn by the EFR, as in FIG. 1, 40. The receiver is what will be tracked to determine the location of the EFR's display device. Alternately, if a hand-held display device is used, the receiver could be mounted directly in or on the device, or a receiver worn by the EFR could be used to compute the position of the device. One possible installation of a tracking system is shown in FIG. 10. Emitters 201 are installed on the outer walls and will provide tracking for the EFR 200 entering the structure.

To correctly determine the EFR's location in three dimensions, the RF tracking system must have at least four non-coplanar transmitters. If the incident space is at or near one elevation, a system having three tracking stations may be used to determine the EFR's location since definite knowledge of the vertical height of the EFR is not needed, and this method would assume the EFRs are at coplanar locations. In any case, the RF receiver would determine either the direction or distance to each transmitter, which would provide the location of the EFR. Alternately, the RF system just described can be implemented in reverse, with the EFR wearing a transmitter (as opposed to the receiver) and using three or more receivers to perform the computation of the display location.

The orientation of the EFR display device can be tracked using inertial or compass type tracking equipment, available through the INTERSENSE CORPORATION (Burlington, Mass.). If a HMD is being used, this type of device 40 can be worn on the display device or on the EFR's head. Additionally, if a hand-held device is used, the orientation tracker could be mounted onto the hand-held device. In an alternate embodiment, two tracking devices can be used together in combination to determine the direction in which the EFR display device is pointing. The tracking equipment could also have a two-axis tilt sensor which measures the pitch and roll of the device.

Alternately to the above embodiments for position and orientation tracking, an inertial/ultrasonic hybrid tracking system, a magnetic tracking system, or an optical tracking system can be used to determine both the position and orientation of the device. These tracking systems would have parts that would be worn or mounted in a similar fashion to the preferred embodiment.

Method for Communicating the Position and Orientation of the EFR Display Device to the Incident Commander. The data regarding the position and orientation of the EFR's display device can then be transmitted to the incident commander by using a transmitter 20 via Radio Frequency Technology. This information is received by a receiver 25 attached to the incident commander's on-site laptop or portable computer 35.

Method for the Incident Commander to View EFR Display Device Position and Orientation Information. The EFR display device position and orientation information is displayed on the incident commander's on-site, laptop or portable computer. In the preferred embodiment, this display may consist of a floor plan of the incident site onto which the EFR's position and head orientation are displayed. This information may be displayed such that the EFR's position is represented as a stick figure with an orientation identical to that of the EFR. The EFR's position and orientation could also be represented by a simple arrow placed at the EFR's position on the incident commander's display.

The path which the EFR has taken may be tracked and displayed to the incident commander so that the incident commander may “see” the route(s) the EFR has taken. The EFR generating the path, a second EFR, and the incident commander could all see the path in their own displays, if desired. If multiple EFRs at an incident scene are using this system, their combined routes can be used to successfully construct routes of safe navigation throughout the incident space. This information could be used to display the paths to the various users of the system, including the EFRs and the incident commander. Since the positions of the EFRs are transmitted to the incident commander, the incident commander may share the positions of the EFRs with some or all members of the EFR team. If desired, the incident commander could also record the positions of the EFRs for feedback at a later time.

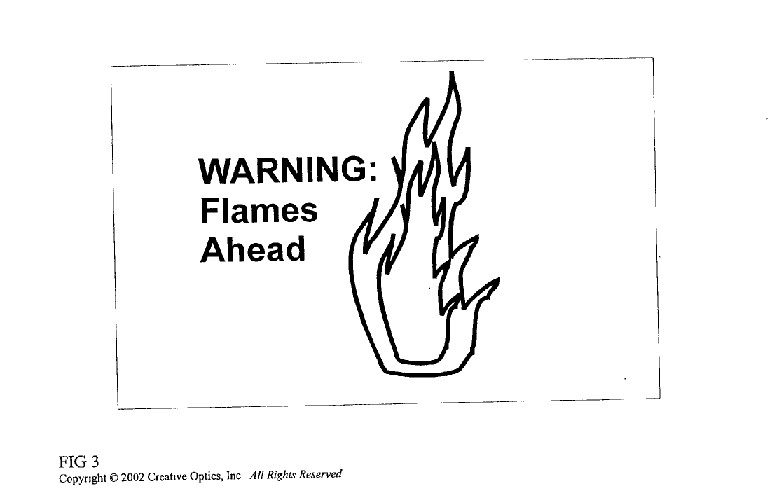

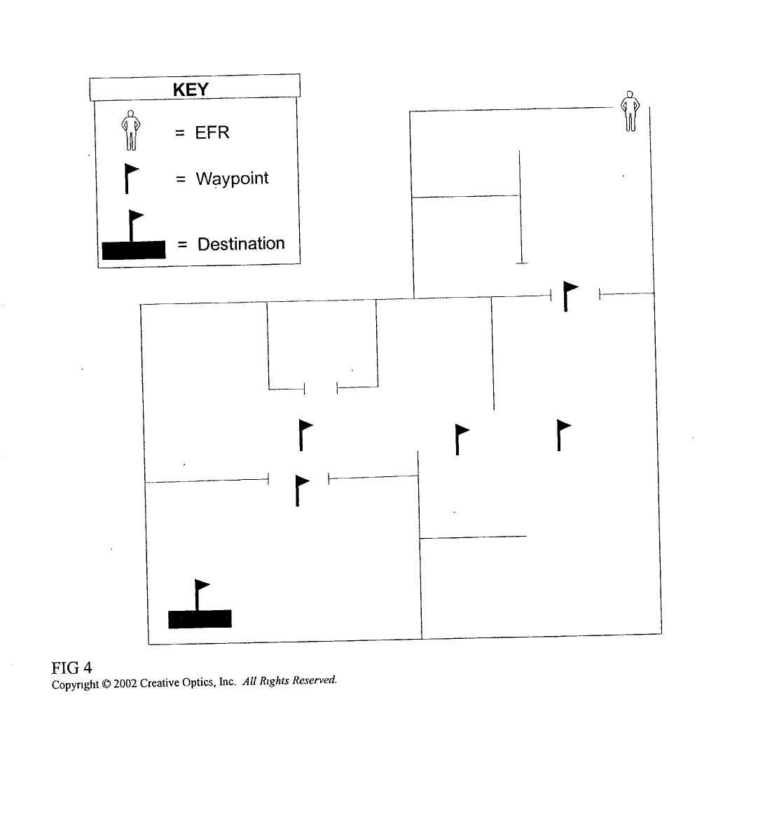

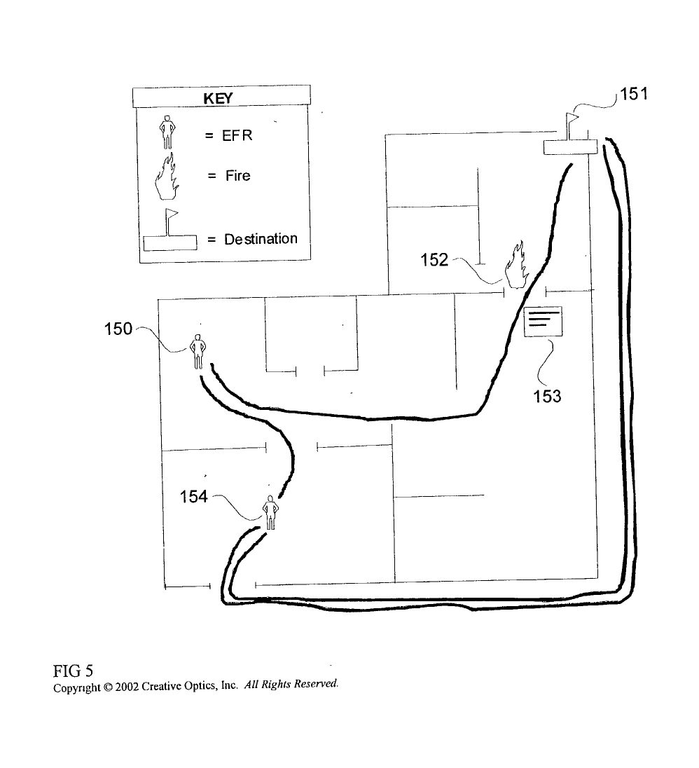

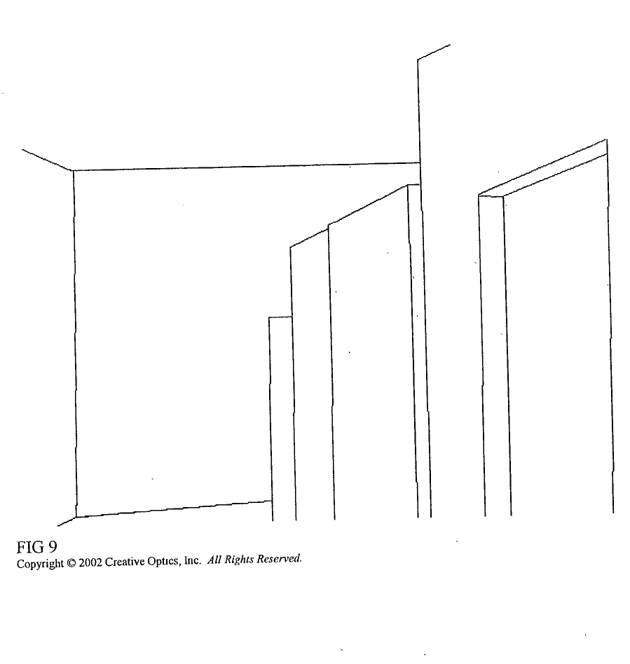

Method for the Incident Commander to Generate Messages to be Sent to the EFR Display Device. Based on the information received by the incident commander regarding the position and orientation of the EFR display device, the incident commander may use his/her computer (located at the incident site) to generate messages for the EFR. The incident commander can generate text messages by typing or by selecting common phrases from a list or menu. Likewise, the incident commander may select, from a list or menu, icons representing situations, actions, and hazards (such as flames or chemical spills) common to an incident site. FIG. 3 is an example of a mixed text and iconic message relating to fire. If the incident commander needs to guide the EFR to a particular location, directional navigation data, such as an arrow, can be generated to indicate in which direction the EFR is to proceed. The incident commander may even generate a set of points in a path (“waypoints”) for the EFR to follow to reach a destination. As the EFR reaches consecutive points along the path, the previous point is removed and the next goal is established via an icon representing the next intermediate point on the path. The final destination can also be marked with a special icon. See FIG. 4 for a diagram of a structure and possible locations of waypoint icons used to guide the EFR from entry point to destination. The path of the EFR 154 can be recorded, and the incident commander may use this information to relay possible escape routes, indicators of hazards 152, 153, and a final destination point 151 to one or more EFRs 150 at the scene (see FIG. 5). Additionally, the EFR could use a wireframe rendering of the incident space (FIG. 9 is an example of such) for navigation within the structure. The two most likely sources of a wireframe model of the incident space are 1 from a database of models that contain the model of the space from previous measurements, or 2 by equipment that the EFRs can wear or carry into the incident space that would generate a model of the room in real time as the EFR traverses the space.

Method for the Incident Commander to Send Messages to the EFR Display Device's Portable Computer. The incident commander will then transmit, via a transmitter and an EFR receiver, the message (as described above) to the EFR's computer. This combination could be radio-based, possibly commercially available technology such as wireless ethernet.

Method for Presenting the Messages to the EFR Using Computer-Generated Images. In the preferred embodiment, once the message is received by the EFR, it is rendered by the EFR's computer, displayed as an image in the EFR's forward view via a Head Mounted Display (HMD) 45.

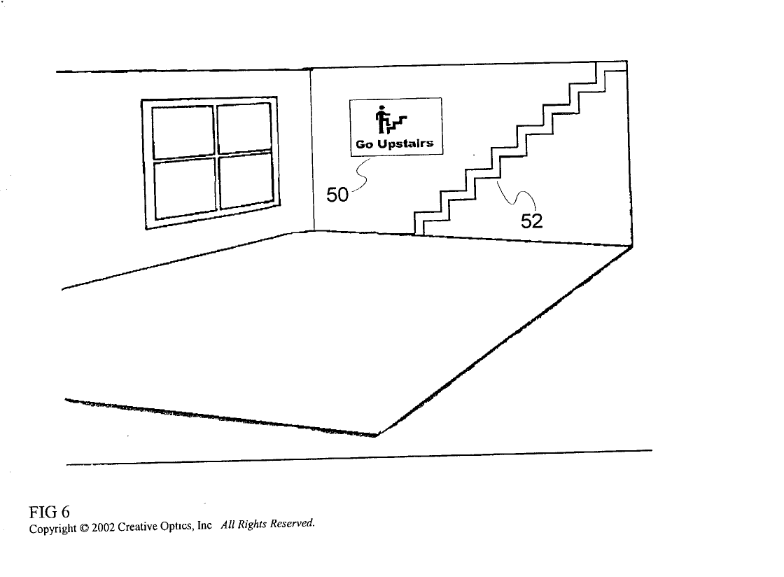

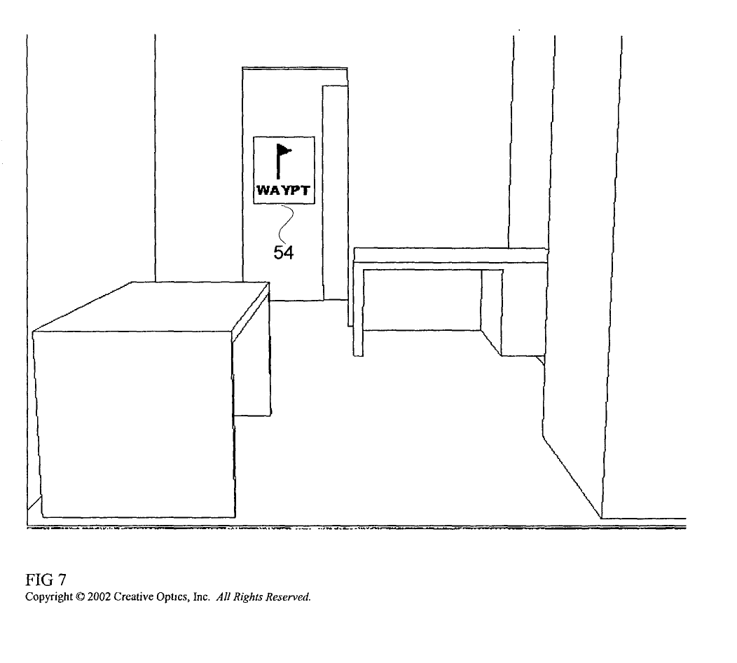

If the data is directional data instructing the EFR where to proceed, the data is rendered and displayed as arrows or as markers or other appropriate icons. FIG. 6 shows a possible mixed text and icon display 50 that conveys the message to the EFR to proceed up the stairs 52. FIG. 7 shows an example of mixed text and icon display 54 of a path waypoint.

Text messages are rendered and displayed as text, and could contain warning data making the EFR aware of dangers of which he/she is presently unaware.

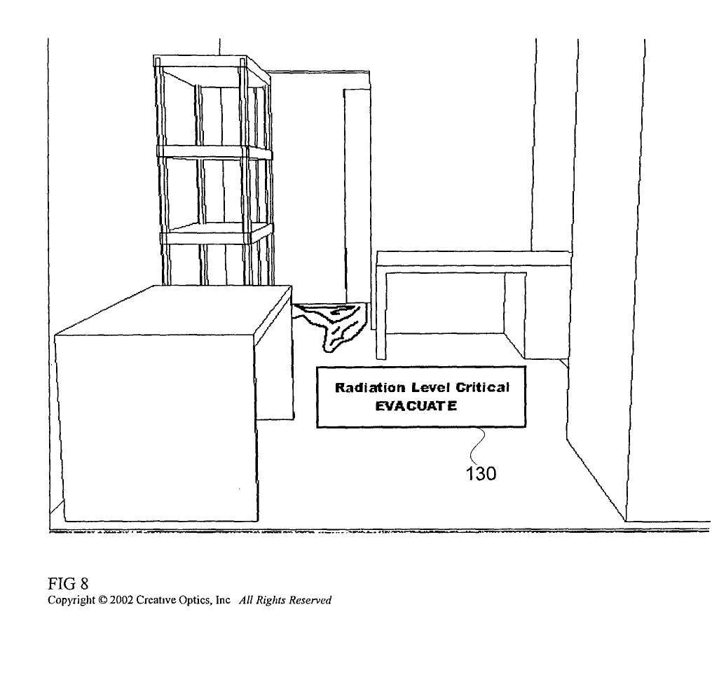

Icons representative of a variety of hazards can be rendered and displayed to the EFR, provided the type and location of the hazard is known. Specifically, different icons could be used for such dangers as a fire, a bomb, a radiation leak, or a chemical spill. See FIG. 8 for a text message 130 relating to a leak of a radioactive substance.

The message may contain data specific to the location and environment in which the incident is taking place. A key code, for example, could be sent to an EFR who is trying to safely traverse a secure installation. Temperature at the EFR's location inside an incident space could be displayed to the EFR provided a sensor is available to measure that temperature. Additionally, temperatures at other locations within the structure could be displayed to the EFR, provided sensors are installed at other locations within the structure.

If the EFR is trying to rescue a victim downed or trapped in a building, a message could be sent from the incident commander to the EFR to assist in handling potential injuries, such as First Aid procedures to aid a victim with a known specific medical condition.

The layout of the incident space can also be displayed to the EFR as a wireframe rendering (see FIG. 9). This is particularly useful in low visibility situations. The geometric model used for this wireframe rendering can be generated in several ways. The model can be created before the incident; the dimensions of the incident space are entered into a computer and the resulting model of the space would be selected by the incident commander and transmitted to the EFR. The model is received and rendered by the EFR's computer to be a wireframe representation of the EFR's surroundings. The model could also be generated at the time of the incident. Technology exists which can use stereoscopic images of a space to construct a 3D-model based on that data. This commercial-off-the-shelf (COTS) equipment could be worn or carried by the EFR while traversing the incident space. The equipment used to generate the 3D model could also be mounted onto a tripod or other stationary mount. This equipment could use either wireless or wired connections. If the generated model is sent to the incident commander's computer, the incident commander's computer can serve as a central repository for data relevant to the incident. In this case, the model generated at the incident scene can be relayed to other EFRs at the scene. Furthermore, if multiple model generators are being used, the results of the various modelers could be combined to create a growing model which could be shared by all users.

Method for Acquiring a View of the Real World. In the preferred embodiment, as explained above, the view of the real world is inherently present through a see-though HMD. This embodiment minimizes necessary system hardware by eliminating the need for additional devices used to capture the images of the real world and to mix the captured real world images with the computer-generated images. Likewise, if the EFR uses a hand-held, see-through display device, the view of the real world is inherently present when the EFR looks through the see-through portion of the device. Embodiments of this method using non-see through devices would capture an image of the real world with a video camera.

Method for Combining the View of the Real World with the Computer-Generated Images and for Presenting the Combination to the EFR. In the preferred embodiment, a see-through display device is used in which the view of the real world is inherently visible to the user. Computer generated images are projected into this device, where they are superimposed onto the view seen by the user. The combined view is created automatically through the use of partial mirrors used in the see-through display device with no additional equipment required.

Other embodiments of this method use both hardware and software components for the mixing of real world and computer-generated imagery. For example, an image of the real world acquired from a camera may be combined with computer generated images using a hardware mixer. The combined view in those embodiments is presented to the EFR on a non-see-through HMD or other non-see-through display device.

Regardless of the method used for combining the images, the result is an augmented view of reality for the EFR for use in both training and actual operations.

What is claimed is:

1. A method for displaying emergency first responder command, control, and safety information comprising:
providing a display device;
obtaining data about the current physical location of the display device;
obtaining data about the current orientation of the display device;
generating 2D and 3D information for the user of the display device by using a computer;
transmitting the information to a computer worn or held by the user;
rendering 3D graphical elements based on the 3D information on the computer worn or held by the user;
creating an overlay of the 2D information on the computer worn or held by the user;
creating for the user a mixed view comprised of an actual view of the real world as it appears in front of the user, where 3D graphical elements can be placed any place in the real world that can be anchored to that place in the real world regardless of the direction in which the user is looking, wherein the rendered 3D graphical elements and 2D information are superimposed on the actual view, to accomplish an augmented reality view.

2. The method of claim 1 in which the user display device is selected from the group of display devices consisting of a Head Mounted Display (HMD), a see-through HMD, a non-see-through HMD, a monocular type of HMD, an HMD integrated into the user's face mask, a hand held display device, a see-through device, and a non-see through device.

3. The method of claim 2 in which the real world image is obtained using a video camera.

4. The method of claim 2 in which the face mask is selected from the group of face masks consisting of a firefighter's SCBA (Self Contained Breathing Apparatus), a face mask that is part of a HAZMAT (Hazardous Materials) suit, a face mask that is part of a radiation suit, and a face mask that is part of a hard hat.

5. The method of claim 2 in which the non-see-through display device obtains an image of the real world using a video camera.

6. The method of claim 2 in which the hand held device is integrated into another device.

7. The method of claim 6 in which the other device is selected from the group of devices consisting of a Thermal Imager, a Navy Firefighter's Thermal Imager (NFTI), and a Geiger counter.

8. The method of claim 1 in which the information transmitted to the user's computer is selected from the group of information consisting of textual data, directional navigation data, iconic information, and a wireframe view of the incident space in which the user is physically located.

9. The method of claim 1 in which the rendered data is selected from the group of rendered data consisting of navigation data, telling the user the direction in which to travel, warning data, telling the user of dangers of which the user may not be aware, environmental temperature at the location of the user, environmental temperature at a location the user is approaching, information pertaining to the area in which the event is occurring to help the user safely and thoroughly perform a task, information pertaining to individuals at an incident site, and an arrow that the user can follow to reach a destination.

10. The method of claim 1 in which a waypoint mode is established in which direction-indicating icons are displayed on the computer worn or held by the user, to create for the user intermediate points along a path that the user can follow in order to reach a final destination.

11. The method of claim 10 in which an icon is displayed to indicate the final destination of the user along the waypoint path.

12. The method of claim 10 in which icons are displayed to represent intermediate points between the user's current location and final destination.

13. The method of claim 10 in which the icon about information is used to represent harmful hazards that are located in an area, the harmful hazard selected from the group of hazards consisting of a fire, a bomb, a radiation leak, and a chemical spill.

14. The method of claim 1 in which the information transmitted to the user's wearable computer originates from a user operating a computing device.

15. The method of claim 8 in which a model is used to show the wireframe representation, wherein the model is obtained from a geometric model created before the time of use.

16. The method of claim 8 in which a model is used to show the wireframe representation, wherein the model is generated at the time of use.

17. The method of claim 16 in which equipment mounted on the user is used to generate the wireframe model of the space.

18. The method of claim 17 in which the model is generated as the user traverses the space.

19. The method of claim 16 in which the equipment used to generate the model of the space the user is in is carried by the user.

20. The method of claim 16 in which the equipment used to generate the model of the space the user is in is on a stationary mount.

21. The method of claim 16 in which the model obtained at the time of use is shared with other users.

22. The method of claim 21 in which the model of the space is shared with other users using wireless connections.

23. The method of claim 21 in which the model of the space is shared with other users using wired connections.

24. The method of claim 21 in which the shared model information is used in conjunction with other model information to create an enlarged model.

25. The method of claim 24 in which the enlarged model is shared and can be used by other users.

26. The method of claim 1 in which obtaining data about the current location and orientation of the display device comprises using a radio frequency tracking technology.

27. The method of claim 26 in which there are at least three radio frequency transmitters located in proximity to the space the user is in, and where the user has a radio frequency receiver.

28. The method of claim 27 in which the radio frequency receiver determines the direction of each of the radio frequency transmitters, and from that it determines the location of the user relative to the transmitter.

29. The method of claim 26 in which the radio frequency receiver determines the distance to each of the radio frequency transmitters, and from that information determines the location of the user relative to the transmitter.

30. The method of claim 26 in which there are at least three radio frequency receivers located in proximity to the space the user is in, and where the user has a radio frequency transmitter on his/her person.

31. The method of claim 30 in which the radio frequency receivers determine the direction of the radio frequency transmitter, and from that determine the location of the user relative to the receivers.

32. The method of claim 30 in which the radio frequency receivers determine the distance of the radio frequency transmitter, and from that information determine the location of the user relative to the receivers.

33. The method of claim 26 in which the tracking equipment on the user is selected from the group of tracking equipment consisting of a compass-type unit that determines the direction of magnetic north, which is used to determine the orientation of the display device relative to the stationary receivers/transmitters, tracking equipment on the user that has two receiver/transmitter units, which are used to determine the orientation of the display device relative to the stationary receivers/transmitters, and tracking equipment on the user that has a tilt sensor that senses tilt in two axes, thereby allowing the tracking technology to know roll and pitch of the user.

34. The method of claim 1 in which the positions of at least one user is shared with others.

35. The method of claim 34 in which the user can see a display of the positions of other users in the space.

36. The method of claim 34 in which the positions of a user are recorded.

37. The method of claim 36 in which the user can see a display of his/her path taken through the space.

38. The method of claim 36 in which a user can see a display of the paths of other users taken through the space.

39. The method in claim 1 in which the method is used in operations.

40. The method in claim 1 in which the method is used in training.

41. The method in claim 1 in which the user is selected from the group of users consisting of an emergency first responder, an outside observer, and an incident commander.
